(19) United States
(12) Patent Application Publication
(10) Pub. No.: US 2017/0370410 A1
(43) Pub. Date: Dec. 28, 2017

(54) SLIDING GUIDE DEVICE FOR MACHINE TOOL

(71) Applicant: OKUMA CORPORATION, Niwa-gun (JP)

(72) Inventor: Takuya Ogawa, Niwa-gun (JP)

(21) Appl. No.: 15/630,038

(22) Filed: Jun. 22, 2017

(30) Foreign Application Priority Data
Jun. 23, 2016 (JP) 2016-124102

(51) Int. Cl. F16C 33/12; F16C 33/04; B23Q 11/12; F16C 33/10; F16C 29/02; F16C 33/20

(52) U.S. Cl. CPC F16C 33/128; F16C 33/122; F16C 29/02; F16C 33/205; B23Q 11/124; F16C 33/1045; F16C 33/043; F16C 2202/10; F16C 2322/39

(57) ABSTRACT

Provided is a sliding guide device for a machine tool, which is capable of supplying an appropriate amount of lubricating oil onto a sliding surface in a stable manner for a long period of time. A movable body is provided with a porous-body accommodation space that is open toward a guide face of a base. The porous-body accommodation space is in communication with a lubricating-oil supply passage that is in communication with an external lubricating oil supply unit. In the porous-body accommodation space, a porous body is disposed in a manner to provide a gap G between the porous body and the guide face of the base.

### CROSS-REFERENCE TO RELATED APPLICATIONS

The present application claims priority under 35 U.S. C. §119 to Japanese Patent Application No. 2016-124102, filed Jun. 23, 2016, entitled “Sliding Guide Device for Machine Tool”. The contents of this application are incorporated herein by reference in their entirety.

### BACKGROUND OF THE INVENTION

### Field of the Invention

The present invention relates to a sliding guide device for a machine tool, which guides a movable body, such as a table, in sliding on a base.

### Description of the Related Art

Industrial machinery, such as machine tools, employs a technique of guiding a structure that moves linearly. The technique includes two types: a sliding guide; and a direct-acting rolling guide. The sliding guide is employed when rigidity and damping properties are required for the industrial machinery to be used.

A sliding guide device for a machine tool is used to slide a movable body and a base relatively, and position them in predetermined positions. The movable body is required to be driven at various speeds and to be positioned with high accuracy. To satisfy the requirements, a sliding part thereof is supplied with lubricating oil, and surfaces on the movable body and the base, which are in relative motion, are subjected to oil film formation whereby the frictional resistance is reduced. A method of supplying the lubricating oil typically includes pressure-feeding lubricating oil to the sliding surfaces, by using a pump.

In addition to supplying lubricating oil using the pump as described above, a known method for supplying lubricating oil is: using an oil-containing polymer or a porous resin; impregnating the polymer or resin with lubricating oil; and placing the resultant polymer or oil so as to contact with the sliding guide face or so as to face the sliding guide face with a gap formed therebetween, which is disclosed in Japanese Unexamined Patent Application Publication No. 8-105439, Japanese Unexamined Patent Application Publication No. 2006-123058, and other patent literatures.

### TECHNICAL PROBLEM

Japanese Unexamined Patent Application Publication No. 8-105439 discloses that a lubrication pad is provided at the sliding part, which serves as lubricating oil supply means. However, it has a problem that, when lubricating oil contained in the lubrication pad runs out due to its use for a long period of time, the lubrication pad needs to be taken out of the device to be re-lubricated, which causes a temporary stop of the machine or requires operating time for the re-lubrication.

The Japanese Unexamined Patent Application Publication No. 2006-123058 discloses that the oil-containing resin is in contact with the sliding surface. However, it has a problem that, when the impregnated lubricating oil runs out due to its long-time operation, because of lack of lubricating-oil supply means, friction reduction capability is reduced whereby abrasion of the sliding surface unfavorably progresses.

The object of the present invention is to provide a sliding guide device for a machine tool, which overcomes the above problems and is capable of supplying an appropriate amount of lubricating oil to a sliding surface in a stable manner for a long period of time.

### SOLUTION TO PROBLEM

The sliding guide device for the machine tool, according to the present invention, is a sliding guide device for a machine tool, the machine tool including a movable body that is slidable on a guide face of a base, and the sliding guide device being provided in the machine tool and being configured to slidingly guide the movable body, wherein the movable body is provided with a groove-shaped or slotted (recessed) porous-body accommodation space that is open toward the guide face of the base, the porous-body accommodation space is in communication with a lubricating oil supply passage into which lubricating oil is supplied from outside of the sliding guide device, and a porous body is disposed in a manner to provide a gap between the porous body and the guide face of the base.

With the sliding guide device for the machine tool, according to the present invention, lubricating oil that has been supplied to the lubricating-oil supply passage from lubricating oil supply means which is disposed outside, is retained and dispersed evenly by the porous body, and is supplied to the sliding surface.

The porous body absorbs excessive lubricating oil accumulated on the sliding surface by capillary action. The porous body thus serves as a re-absorption mechanism for lubricating oil that has once been supplied.

Therefore, the amount of lubricating oil to be discharged from the sliding surface is reduced, and as a result, the time interval for operating the external lubricating oil supply means (for example, a pump) configured to supply lubricating oil from outside may be set longer as compared to the conventional case. In addition, an appropriate amount of lubricating oil is supplied to the sliding surface at an appropriate time interval and in a stable manner. Furthermore, the amount of the lubricating oil remaining on the sliding surface may be maintained appropriately. Therefore, excessive supply of lubricating oil is suppressed, the consumption amount and the disposed amount of lubricating oil are reduced, and excessive lifting-off of the movable body is prevented.

Because there exists a gap between the porous body and the guide face of the base, the load of the movable body is directly applied to the base, and the porous body therefore possesses sufficient rigidity against the burden and impact caused during the cutting operation of the machine tool. As a result, the abrasion of the porous body is also suppressed. In addition, when lubricating oil passes through the porous body, foreign matter contaminating the lubricating oil is captured. The porous body is thus expected to have a filtering effect whereby clean lubricating oil is supplied to the sliding surface.

Examples of foamed materials used for the porous body include plastic foam, ceramic foam, and foam metal. A nonwoven fabric also may be used.

For the porous body, as a matter of course, only one appropriate type of foam may be used, but it is more preferable that the porous body includes at least two types of foams having different expansion ratios and laminated in order of expansion ratio, and that the porous laminates are arranged in a manner that a surface of the laminate having a smaller expansion ratio faces the guide face of the base.

The above-described configuration enhances the filtering effect of the porous body.

The porous body may be a closed-cell porous body or may be an open-cell porous body. However, the open-cell porous body, in which several cells are continuously interconnected, is more preferable, because the open-cell porous body has an improved capability of absorbing lubricating oil.

One porous-body accommodation space may be provided on a face on which the movable body contacts the guide face of the base. However, it is more preferable that a plurality of the porous-body accommodation spaces are provided on the face on which the movable body contacts the guide face of the base. In this case, all the porous-body accommodation spaces are provided with the porous bodies, and all the porous-body accommodation spaces may be provided with the lubricating oil supply passages or some of the porous-body accommodation spaces may be provided with the lubricating oil supply passages. Even in the case where the porous-body accommodation space is not provided with the lubricating-oil supply passage, the porous body in the porous-body accommodation space without the lubricating-oil supply passage serves as a re-absorption mechanism for lubricating oil whereby the porous body contributes to supplying an appropriate amount of lubricating oil to the sliding surface stably for a long period of time. In terms of the advantageous mechanism of the porous body, the lubricating-oil supply passage is more preferably provided to some of the plurality of the porous-body accommodation spaces.

### ADVANTAGEOUS EFFECTS OF INVENTION

According to the sliding guide device for the machine tool, of the present invention, the time interval for operating the external lubricating oil supply means configured to supply lubricating oil from outside may be set longer as compared to the conventional case. In addition, an appropriate amount of lubricating oil is supplied to the sliding surface at an appropriate time interval and in a stable manner. Furthermore, the amount of the lubricating oil remaining on the sliding surface may be maintained appropriately. Therefore, excessive supply of lubricating oil is suppressed, the consumption amount and the disposed amount of lubricating oil are reduced, and excessive lifting-off of the movable body is prevented. In addition, because the porous body has a filtering effect, clean lubricating oil is supplied to the sliding surface.

### BRIEF DESCRIPTION OF DRAWINGS

FIG. 1 is a longitudinal sectional view schematically showing a sliding guide device of a machine tool according to one embodiment of the present invention.

FIG. 2 is an enlarged longitudinal sectional view of the sliding guide device.

FIG. 3A is a bottom view showing an example of arrangement of porous bodies in the sliding guide device.

FIG. 3B is a bottom view showing an example of arrangement of porous bodies in the sliding guide device.

FIG. 3C is a bottom view showing an example of arrangement of porous bodies in the sliding guide device.

FIG. 3D is a bottom view showing an example of arrangement of a porous body in the sliding guide device.

FIG. 4A is a bottom view showing an example of arrangement of porous bodies in the sliding guide device, in terms of the sliding direction.

FIG. 4B is a bottom view showing an example of arrangement of porous bodies in the sliding guide device, in terms of the sliding direction.

FIG. 5 is an enlarged longitudinal sectional view of a sliding surface according to another embodiment of the sliding guide device.

FIG. 6 is an enlarged longitudinal sectional view of a porous body according to another embodiment of the sliding guide device.

### DESCRIPTION OF EMBODIMENTS

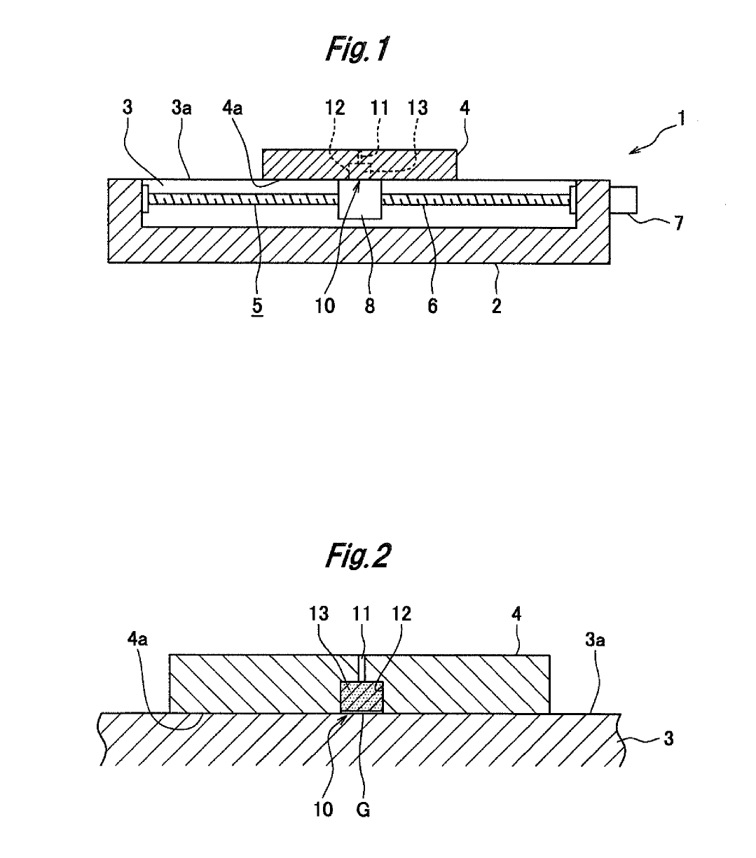

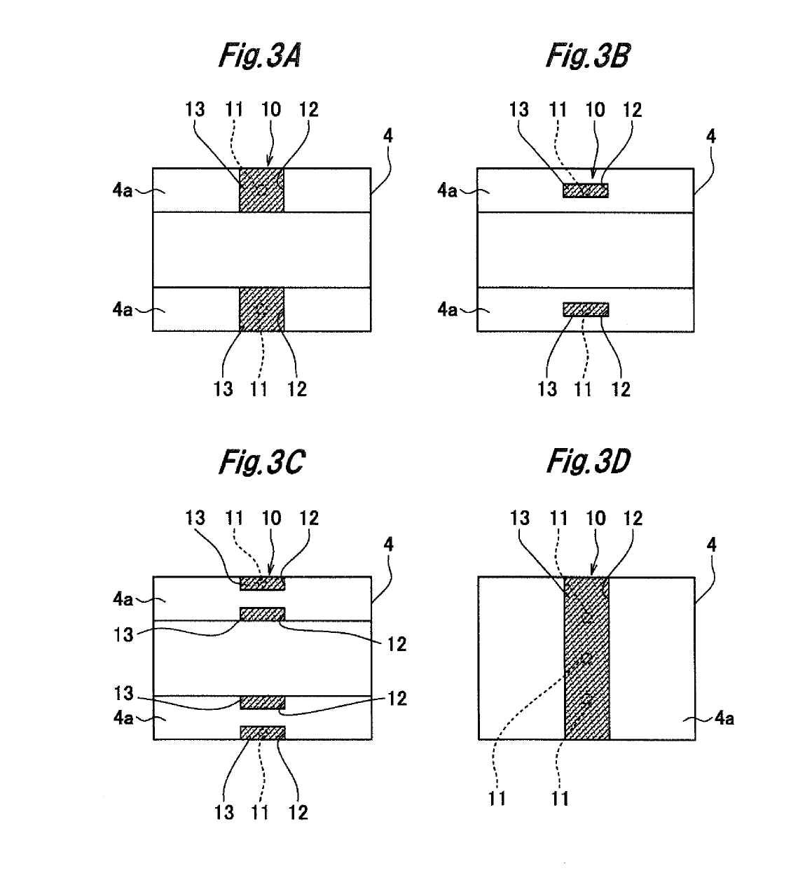

Embodiments of a sliding guide device for a machine tool according to the present invention will now be described with reference to FIG. 1 to FIG. 6. Hereafter, the left side of FIG. 1 is referred to as the front, and the right side thereof is referred to as the rear. The upper side of each of FIGS. 3A to 3D is referred to as the right, and the lower side thereof is referred to as the left.

FIG. 1 schematically shows the sliding guide device for the machine tool. The machine tool (1) includes a base (2), a movable body (4) that slides in the front-rear direction along the movable-body support member (3) provided on the base (2), a drive unit (5) that moves the movable body (4) in the front-rear direction, and a sliding guide device (10) that reduces friction at the time of a sliding movement of the movable body (4) over the base (2).

The base (2) is provided at a center in the right-left direction thereof with one movable-body support member (3), for example. In this case, a contact face (4a) of the movable body (4), which contacts the base (2), is one flat surface (FIG. 3D shows one example of this case). In some cases, a right and left pair of movable-body support members (3) are provided at the right and left sides of the base (2). In such a case, a right and left pair of the contact faces (4a) of the movable body (4), which contact the base (2), are formed (FIGS. 3A, 3B, and 3C show examples of such a case).

The drive unit (5) includes a ball screw (6) extending in the front-rear direction, and a motor (7) that turns the ball screw (6). The movable body (4) is integrally provided at a lower surface thereof with a nut portion (8) to be screwed together with the ball screw (6). The contact face (4a) of the movable body (4) is in surface contact with the guide face (3a) formed on an upper surface of the movable-body support member (3). The movable body (4) is slidably moved with respect to the base (2) by the drive unit (5).

The sliding guide device (10) is designed to supply lubricating oil to a sliding part between the upper surface of the movable-body support member (3) of the base (2) and the contact face (4a) of the movable body (4). As shown in FIG. 2 in an enlarged manner, the sliding guide device (10) includes a lubricating-oil supply passage (11) that is connected to an unillustrated pump (external lubricating-oil supply means). The sliding guide device (10) is provided, on the contact face (4a) of the movable body (4), with a porous-body accommodation space (12) that is groove-shaped or slotted (recessed). Inside the porous-body accommodation space (12), a porous body (13) is disposed.

The porous-body accommodation space (12) is provided in a direction perpendicular to the sliding direction of the movable body (4), has the shape of a square in cross section, and is open downward.

The lubricating-oil supply passage (11) extends vertically, and is disposed so as to be open toward the upper surface of the porous-body accommodation space (12). The appropriate number of the lubricating-oil supply passage (11) to be disposed in the right-left direction is one or more.

The porous body (13) has the shape of a square in cross section, and disposed within the porous-body accommodation space (12). The lower surface of the porous body (13) is not in contact with the guide face (3a) of the movable-body support member (3) of the base (2). A gap (G) is provided between the lower surface of the porous body (13) and the guide face (3a) of the movable-body support member (3) of the base (2).

Examples of foamed materials used for the porous body (13) include plastic foam, ceramic foam, and foam metal. The porous body (13) is preferably of an open-cell type in which cells in the material are interconnected with one another.

The number, shape, and arrangement position of the porous-body accommodation space (12) in which the porous body (13) is disposed may be appropriately determined.

For example, when the porous-body accommodation space (12) and the porous body (13) are viewed from the bottom, the porous-body accommodation space (12) may be formed and the porous body (13) may be disposed therein, over the entire width of each of the right and left contact faces (4a), as shown in FIG. 3A. As shown in FIG. 3B, the porous-body accommodation space (12) may be formed and the porous body (13) may be disposed therein, at a center portion in the width direction of each of the right and left contact faces (4a). Alternatively, a plurality of (two in FIG. 3C) the porous-body accommodation spaces (12) may be formed with a predetermined interval therebetween in the right-left direction on each contact face (4a), as shown in FIG. 3C. Alternatively, as shown in FIG. 3D, in a case where the contact face (4a) is one flat surface, one porous-body accommodation space (12) may be formed and one porous body (13) may be disposed therein to run the entire width of the contact face (4a).

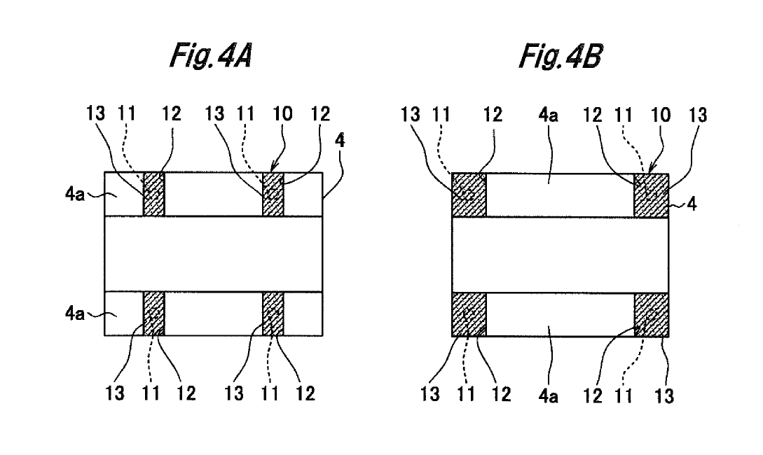

In another example, a plurality of (two in FIGS. 4A and 4B) porous-body accommodation spaces (12) may be formed with a predetermined interval therebetween in the front-rear direction on each contact face (4a), as shown in FIG. 4A and FIG. 4B.

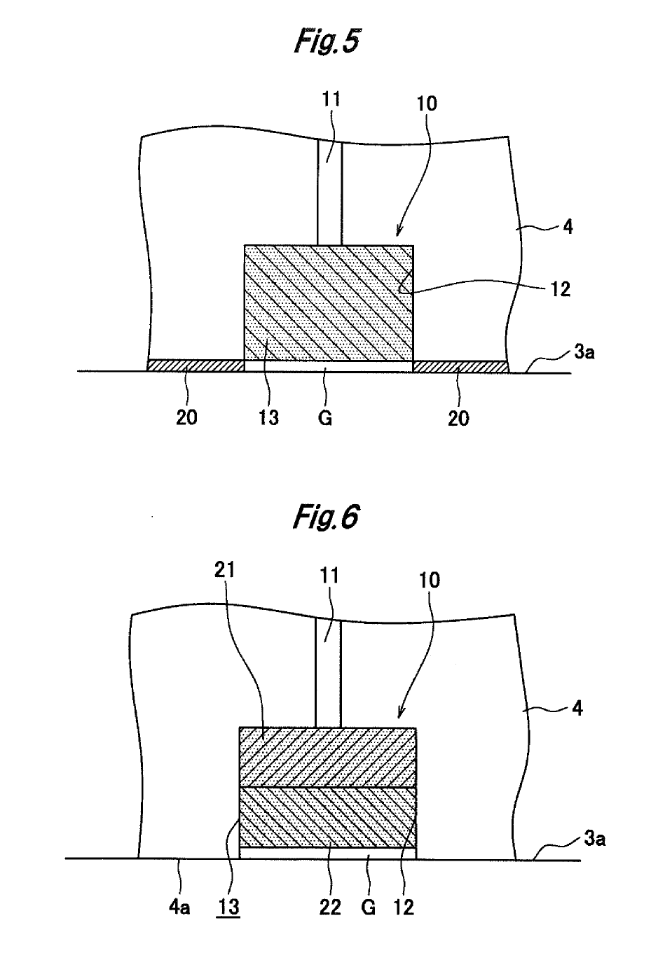

To reduce sliding resistance in the sliding guide device (10), the movable body (4) may have a lower face to which a resin material (low frictional material) (20) such as fluororesin may be attached, as shown in FIG. 5.

As shown in FIG. 6, the porous body (13) may have a laminate structure composed of an upper layer (21) and a lower layer (22). The number of layer may be two as shown in FIG. 6, or may be three or more. The laminate structure is formed by sticking together layers having two or more different expansion ratios and consisting of the same material or different materials.

In the case where the movable body (4) has two (plurality of) contact faces as shown in FIGS. 3A to 3C and FIGS. 4A and 4B, the positions of the porous-body accommodation spaces (12) are desirably aligned with respect to the sliding direction so as to apply the same degree of the dynamic pressure caused by movement of the movable body (4), to the contact faces.

The number of the lubricating-oil supply passage (11) is determined appropriately. When a plurality of groups of the porous-body accommodation spaces (12) are provided, at least one group of the lubricating-oil supply passages (11) are provided. The lubricating-oil supply passage (11) runs through the movable body (4) and is connected to a lubricating-oil supply pump. A predetermined amount of lubricating oil is supplied from the lubricating-oil supply passage (11) at a set time interval.

When the plurality of the porous-body accommodation space (12) are provided, all the porous-body accommodation spaces (12), of course, may be in communication with the lubricating-oil supply passages (11), but, as shown in FIG. 3C, only one of the pair of the porous-body accommodation spaces (12) may be provided with the lubricating-oil supply passage (11), and the other of the pair is not provided with the lubricating-oil supply passage (11).

When the lubricating oil is pressure-fed to the lubricating-oil supply passage (11) by a pump, part of the lubricating oil is absorbed into the porous body (13), and the remaining lubricating oil is supplied through an opening of the porous-body accommodation space (12) to the guide face (3a) of the movable-body support member (3).

The length of the porous-body accommodation space (12) in the sliding direction may be set arbitrarily in accordance with the pressure on the contact face between the movable body (4) and the base (2). The device to be used for carrying heavy loads may have a small opening area of the porous-body accommodation space (12) and have a large contact area between the movable body (4) and the guide face (3a) of the movable-body support member(3) of the guide face (3a) whereby the surface pressure is alleviated.

The material of the contact face (4a) of the movable body (4), which comes in contact with the base (2), may be selected from: steel used for forming the movable body (4); metal such as cast iron; and products of such steel and metal that have undergone heat treatment as required for the purpose of improving its abrasion resistance and strength.

The porous body (13) is molded or cut such that the porous-body accommodation space (12) accommodates the porous body (13). The porous body (13) thus shaped is disposed in the porous-body accommodation space (12). When the porous body (13) is pasted, the thickness of the porous body (13) is determined so as to have a gap (G) between the porous body (13) and the guide face (3a) of the movable-body support member (3) of the base (2), whereby the abrasion of the porous body (13) is suppressed. In addition, because the porous body (13) does not directly support the load, the porous body (13) does not need to have strength and therefore can increase its expansion ratio.

When the thickness of the lubricating oil film on the sliding surface is greater than or equal to the thickness of the gap (G) that is formed, the lubricating oil comes in contact with the porous body (13). The lubricating oil that accumulates unnecessarily on the sliding surface is absorbed into the porous body (13) by capillary action. The absorbed oil is retained in the porous body (13) and is less likely to be discharged to the outside of the sliding surface. The absorbed lubricating oil drops by gravity to contribute to lubrication of the sliding surface again. In the case where the absorption effect is especially expected, the porous-body accommodation space (12) to which the porous body (13) that is expected to have the absorption effect is pasted, may not be provided with the lubricating-oil supply passage (11), as shown in FIG. 3C.

One of the front and rear porous-body accommodation spaces (12) as shown in FIG. 4A and FIG. 4B may not be provided with a lubricating-oil supply passage (11).

Because the porous-body accommodation space (12) is provided on the upper face (bottom face) thereof with the lubricating-oil supply passage (11), lubricating oil that is supplied passes through the porous body (13) to be supplied to the sliding surface. An open-cell porous body (13) allows the lubricating oil inside the porous body (13) to be dispersed evenly. Furthermore, because the plurality of the lubricating-oil supply passages (11) are disposed, uneven dispersion of the lubricating oil within the porous body (13) is further reduced. The porous body (13) acts to retain lubricating oil, and at the same time serves as a filter to filter out foreign matter contained in the lubricating oil when the lubricating oil passes therethrough. Therefore, it is possible to supply clean lubricating oil to the sliding surface. An appropriate amount of lubricating oil is thus supplied to the sliding surface for a long period of time and in a stable manner.

The thickness of the porous body (13) determines the time necessary for the lubricating oil that has been supplied from the lubricating-oil supply passage (11) to reach the sliding surface. At this time, the amount of oil to be supplied to the sliding surface is determined by the time interval of the oil supply by the pump and the expansion ratio of the porous body (13). For example, under the condition where the contact face pressure is high, decrease of the oil film thickness is expected. Under such a circumstance, the thickness of the porous body (13) may be reduced, or the porous body (13) having a great expansion ratio may be employed.

Needless to say, the depth (vertical dimension) of the porous-body accommodation space (12) is determined in light of the factors described above.

Especially in the case where the filtering effect is to be enhanced, it is desired that the porous body (13) is a laminate composed of at least two layers as shown in FIG. 6, and that these layers are laminated in order of expansion ratio with the layer having a greater expansion ratio being arranged in the upper layer. Furthermore, when the laminate of the porous body (13) is disposed in the porous-body accommodation space (12), it is desired that a porous body having a relatively small expansion ratio is placed in the lower layer (22) and that a porous body having a relatively great expansion ratio is placed in the upper layer (21). With this structure, the porous body having a greater expansion ratio is pasted such that the face of the porous body having the greater expansion ratio comes in contact with the bottom face of the porous-body accommodation space (12), and the porous body having a smaller expansion ratio is disposed so as to face the guide face (3a) of the movable-body support member (3) of the base (2).

When the porous body (13) is placed in each of the plurality of the porous-body accommodation space (12) disposed, each porous body (13) does not need to have the identical structure with one another. For example, a porous body (13) composed of the porous laminates (21) and (22) may be used to be placed in the porous-body accommodation space (12) provided with the lubricating-oil supply passage (11), and a single-layer porous body (13) may be used to be placed in the porous-body accommodation space (12) without the lubricating-oil supply passage (11).

### REFERENCE SIGNS LIST

(1): machine tool
(2): base
(3a): guide face
(4): movable body
(10): sliding guide device
(11): lubricating-oil supply passage
(12): porous-body accommodation space
(13): porous body
(21): upper layer
(22): lower layer
(G): gap

What is claimed is:

1. A sliding guide device for a machine tool, the machine tool including a movable body that is slidable on a guide face of a base, and the sliding guide device being provided in the machine tool and being configured to slidingly guide the movable body, wherein
the movable body is provided with a porous-body accommodation space that is open toward the guide face of the base, the porous-body accommodation space is in communication with a lubricating-oil supply passage into which lubricating oil is supplied from outside of the sliding guide device, and a porous body is disposed in a manner to provide a gap between the porous body and the guide face of the base.

2. The sliding guide device for the machine tool, according to claim 1, wherein
the porous body includes at least two foams having different expansion ratios and laminated in order of expansion ratio, in a manner that one of the foams having a smallest expansion ratio faces the guide face of the base.

3. The sliding guide device for the machine tool, according to claim 1, wherein
the porous body is an open-cell porous body.

4. The sliding guide device for the machine tool, according to claim 1, wherein
a plurality of the porous-body accommodation spaces are provided on a face on which the movable body contacts the guide face of the base.

5. The sliding guide device for the machine tool, according to claim 4, wherein
all the porous-body accommodation spaces are provided with the porous bodies, and all the porous-body accommodation spaces are provided with the lubricating-oil supply passages.

6. The sliding guide device for the machine tool, according to claim 4, wherein
all the porous-body accommodation spaces are provided with the porous bodies, and some of the porous-body accommodation spaces are provided with the lubricating-oil supply passages.
